(19) United States
(12) Patent Application Publication
(10) Pub. No.: US 2006/0056904 A1
(43) Pub. Date: Mar. 16, 2006

(54) Capillary tube printing tips for microarray printing

(76) Inventors: Frederick R Haselton, Nashville, TN (US); Mark K McQuain, Nashville, TN (US)

Correspondence Address: STITES & HARBISON PLLC, 424 CHURCH STREET, SUITE 1800, NASHVILLE, TN, 37219-2376, US

(21) Appl. No.: 10/513,803

(22) PCT Filed: Oct. 7, 2002
(86) PCT No.: PCT/US02/32000

§ 371 Date: Nov. 8, 2004

Related U.S. Application Data
(60) Provisional application No. 60/327,236, filed on Oct. 5, 2001.

(51) Int. Cl. B01L 3/02

(52) U.S. Cl. 401/198; 422/100

(57) ABSTRACT

A microarray contact printing is formed from at least one capillary tube. The tip has concentric reservoir and printing capillary tubes, with a first capillary tube (24) and a second capillary tube (22) having an inner bore (26) with an inner diameter larger than an outer diameter of the first capillar tube (24) so that the second capillary tube (22) partially overlaps a proximal end of the first capillary tube (24). The first capillary tube (24) has a contact surface (36) at a distal end. The inner bore of the first capillary tube (24) is adapted for drawing the printing solution retained in the second capillary tube (22) and depositing a drop of a solution on a printing substrate when the contact surface (36) is moved proximate the substrate.

A portion of the disclosure of this patent document contains material that is subject to copyright protection. The copyright owner has no objection to the facsimile reproduction by anyone of the patent document or the patent disclosure, as it appears in the Patent and Trademark office patent file or records, but otherwise reserves all copyright rights whatsoever.

### TECHNICAL FIELD

The present invention relates generally to devices and methods used for microarray printing. More particularly, this invention pertains to printing tips used for depositing spots of liquid material across a microarray printing substrate.

### BACKGROUND ART

DNA microarrays and other massively parallel screening technologies are redefining the approach to discovery in biomedical research. One key aspect to interpreting these parallel screening approaches is the uniformity of conditions across the probe screen. Significant variability across DNA microarrays is often observed and as a result typical DNA microarray hybridization results often discard much of the data. One of the reasons for this is inadequate control of the chip manufacturing process. The development of technologies which increase the efficacy of DNA chip printing are therefore highly desirable. Such advances will establish lower limits of detectability for currently existing procedures, as well as extend the utility of microarrays as a platform technology into novel applications.

Most microarrays are produced by depositing nanoliter or picoliter quantities of a probe DNA solution across the array substrate to form 100 to 200 um diameter spots. Large microarrays may contain thousands of unique spots deposited at densities exceeding 4000 spots/cm². The quantity of probe DNA comprising each spot is determined by the deposition volume and resulting spot morphology. Variations in volume and morphology affect the probe density of the spot, which can influence important analysis parameters including hybridization specificity, dynamic range, and relative hybridization intensity among spots. Controlled and consistent deposition of the probe DNA solution onto the microarray substrate is an important factor in accurate microarray analysis. Inter-spot consistency is another important factor. Variations in deposition can alter spot characteristics which affect comparisons between different spots. Variations from spot-to-spot necessitates the use of self-normalizing experimental designs such as performed in two color differential gene expression. If spot-to-spot variation could be reduced, more robust experimental designs such as single label hybridization studies would be much more feasible and produce more reliable data which could be compared across experiments.

Ideally, the method of depositing the probe solution onto the array would provide for precise and consistent control of both spot volume and morphology. Precise control allows the quantity of deposited probe solution to be optimized for the selected method of attachment chemistry. Consistency insures that all probe spots on the array have similar probe densities, size, and therefore similar hybridization characteristics. Additionally, ideal characteristics include negligible evaporation from the deposition device so that multiple sample depositions by the same device over a period of time will have the same concentration. Printing strategies also require that loading the device with probe DNA solutions minimizes sample evaporation from the storage plates. This may be an important factor for high density arrays and ensures that uniform sample concentrations are maintained for subsequent prints. For non-disposable tips, cleaning must be rapid and thorough to prevent sample carryover from consecutive loads of different probe solutions.

Most microarrays are currently produced by some form of contact printing. Contact printing is popular because it offers a good balance of cost and performance. It requires only a tiny fraction of the start-up costs associated with photo-lithographic in-situ synthesis methods and is versatile enough to print large arrays with thousands of unique spots. Compared to photolithographic and ink jet printing methods, contact printing is less technically complex. Its simple and inherently passive operational requirements make it popular with many small microarray printing facilities such as academic core labs.

Current methods of depositing printing solution include solid pins, quill pins, and ink jets. Quill pins have a narrow slit at their tip which acts as a fluid reservoir during the printing process. Each time the pin contacts the substrate, it deposits solution from the slit reservoir which holds a sufficient volume to print multiple spots from a single load of probe solution. The volume and morphology of the spots depends on the equilibrium state between the pin tip and substrate and is influenced by factors like surface tension of the printing solution, and hydrophobic characteristics of the substrate and pin. Quill pins are more difficult to clean and are not as consistent as solid pins because the delicate design of the quill pin geometry makes them susceptible to deformation. Special humidity conditions are often employed to reduce evaporation from the pins during printing to maximize spot repeatability. Their chief advantage is speed resulting from their ability to print multiple spots from a single sample loading.

Solid pins have a small flat tip that is dipped into printing solution before each deposition. When removed from the printing solution, a small bubble of solution remains on the hydrophilic tip of the pin and is deposited as the pin contacts the substrate. The volume and morphology of the spot depends on the tip size, surface tension of the printing solution and hydrophobic character of the substrate. Solid pins are easy to clean and provide good spot-to-spot consistency because of simple, rugged design that facilitates both inter- and intra-pin uniformity. Their primary drawback is slow deposition speed because they must be reloaded before printing each spot. Evaporation from the sample plates during lengthy print runs can also be a problem.

Ink jet printing methods use a pressure pulse to eject a small quantity of probe solution through a small nozzle onto the array. The volume and morphology of deposition is relatively consistent and can be controlled by adjusting the characteristics of the ejection pulse. The rate of deposition is extremely fast because the ink jet is not required to contact the substrate. Evaporation of printing solution from inkjets is minimal so spot consistency over multiple depositions is excellent. Their main drawback is difficulty in cleaning and reloading. Typical ink jets are not designed for multiple samples so each unique probe solution would require its own ink jet device; a serious drawback for large arrays.

Microfluidic analysis of fluid transfer at this scale appears to be a relatively poorly understood process. However, several key features are readily apparent. Pin loading by “capillary action” is one of the surprising features of the fluid-surface interface at this scale. Theoretical expressions describing this have been attributed to Rayleigh. For a hollow, round tube, the capillary rise height (defined as the distance fluid will travel up into a tube after submerging one end in a reservoir) is governed by fluid properties and the subsequent contact angle between the fluid and the pin capillary inner surface. This distance can be quite large. For example, in a 25 micron inner diameter tube, water will rise to a height of 58 cm. The time to equilibrium has also been investigated and has been shown to be dependent on the fluid-surface interface characteristics. For the same 25 micron tube with a length of 1 cm, the characteristic rise time is approximately 300 ms.

Non-dimensional groups are another useful tool for describing the dominate forces in this microfluidic environment. The Weber number, We, describes the ratio of inertial to surface tension forces, and is given by DV²ρ/g_{c}σ where D is the characteristic length, g_{c} is a dimensionless constant, ρ is the density, σ is the surface tension, and V is the velocity. The Froude number, Fr, describes the ratio of inertial to gravitational forces, and is given by V²/gL where V is again characteristic velocity, L is characteristic length, and g is gravitational acceleration. The ratio of these ratios (Fr/We) is a relative measure of the surface forces to gravitational forces and is given by g_{c}/L² pg. For a characteristic dimension of 25 microns, and fluid properties of water, this ratio is approximately 500. Since this value is much greater than 1, this lends support to the idea that surface forces dominate.

The key characteristic is minimum variation among spots printed with a single tip and minimum variation among spots printed with different tips of the same design. Several other secondary factors are important for commercial success. One of these is the overall speed of the printing process. Besides the obvious cost of robot time, sample evaporation and changes in slide surface chemistry also need to be minimized. Another factor is sample waste. Residual sample after printing is typically not returned to the sample well. As noted above for a 25 micron characteristic dimension, the volume loaded is 300 nl. Neglecting any evaporation loss, this is sufficient to print >400 slides. A means to control the volume loaded would be highly desirable. This would greatly reduce the sample discarded and the number of slides obtainable from a sample plate.

What is needed, then, is a printing tip for transferring sub-nanoliter liquid samples to a high density array printed on a flat surface which is suitable for high-speed robotic printing. These tips will find application in DNA arrays as well as any other liquid handling process in which picoliter to nanoliter quantities are rapidly and precisely transferred from a liquid reservoir to a flat solid surface.

### DISCLOSURE OF THE INVENTION

The present invention provides significant improvements in microarray printing tip technology through the use of capillary tube printing tips. Several embodiments of capillary tube printing tips are disclosed herein.

The invention provides a simple printing tip. Tip loading is achieved by surface forces and capillary action. Pin delivery is achieved by touching the tip to the surface of a microarray printing substrate. One important aspect of the design is the flatness of the tip. This can be achieved on a glass tip by using an optical fiber polisher. A single load can be dispensed without reloading onto many consecutive substrate surfaces. In addition, drop-to-drop variation is minimal. Unlike quill pins, the volume transferred to the surface equilibrates very rapidly making the deposition characteristics time independent. The simplicity of the design also suggests that pin-to-pin variation will be insignificant. The tip design can be easily modified to deliver drops over a range of sizes and volumes. These tips may be produced at low cost so that they may be discarded between samples. This will obviate the need for a wash cycle and eliminate cross contamination issues.

Preferably, means are provided in the design of the tip to provide increased surface forces to the liquid material near the distal end of the tip so that the liquid material is continuously drawn down the tip for deposition.

In a first embodiment of the invention, a tip for depositing spots of a liquid material on a microarray printing substrate includes a capillary tube having a distal end, a proximal end, and an inner bore. The inner bore has a bore opening at the distal and proximal ends of the tube. The inner bore has an axial length and inner diameter adapted to receive and retain by capillary force an effective deposition volume of the liquid material. Further, the distal end of the capillary tube has an annular contact surface around the distal bore opening. The inner bore has a minimum diameter at the contact surface which expands to a larger diameter towards the proximal end. The contact surface and distal bore opening are adapted for drawing the liquid material from the inner bore and depositing a drop of the liquid material on the printing substrate when the contact surface is moved proximate the substrate.

In a second embodiment, a contact printing tip is formed from concentric reservoir and printing capillary tubes, with the second capillary tube having an inner bore with an inner diameter that is larger than an outer diameter of the first capillary tube so that the second capillary tube partially overlaps a proximal end of the first capillary tube. The first capillary tube also has having an inner bore in fluid communication with the inner bore of the second capillary tube. The first capillary tube further comprises a contact surface at a distal end with the contact surface surrounding an opening from the inner bore of the first capillary tube. The inner bore of the second capillary tube is adapted to receive and retain an amount of the liquid material and the inner bore of the first capillary tube is adapted for drawing the liquid material retained in the inner bore of the second capillary tube by capillary action and depositing a drop of the liquid material on the printing substrate when the contact surface is moved proximate the substrate.

In a third embodiment, a tip for depositing spots of a liquid material on a microarray printing substrate includes a capillary tube having a distal end, a proximal end, and an inner bore. The inner bore has a bore opening at the distal and proximal ends of the tube. The inner bore has an axial length and inner diameter adapted to receive and retain by capillary force an effective deposition volume of the liquid material. Further, the distal end of the capillary tube has an annular contact surface around the distal bore opening. In this uniform inner bore geometry the change in surface forces to achieve a more hydrophilic region near the contact surface of the tube uses coatings applied to the inner bore so that surface forces near the distal end of the tip are greater than surface forces in the remainder of the inner bore. The contact surface and distal bore opening are adapted for drawing the liquid material from the inner bore and depositing a drop of the liquid material on the printing substrate when the contact surface is moved proximate the substrate.

Accordingly, it is an object of the present invention to provide an improved microarray printing tip.

Other and further objects, features and advantages of the invention will be readily apparent to those skilled in the art upon a reading of the following disclosure when taken in conjunction with the accompanying drawings.

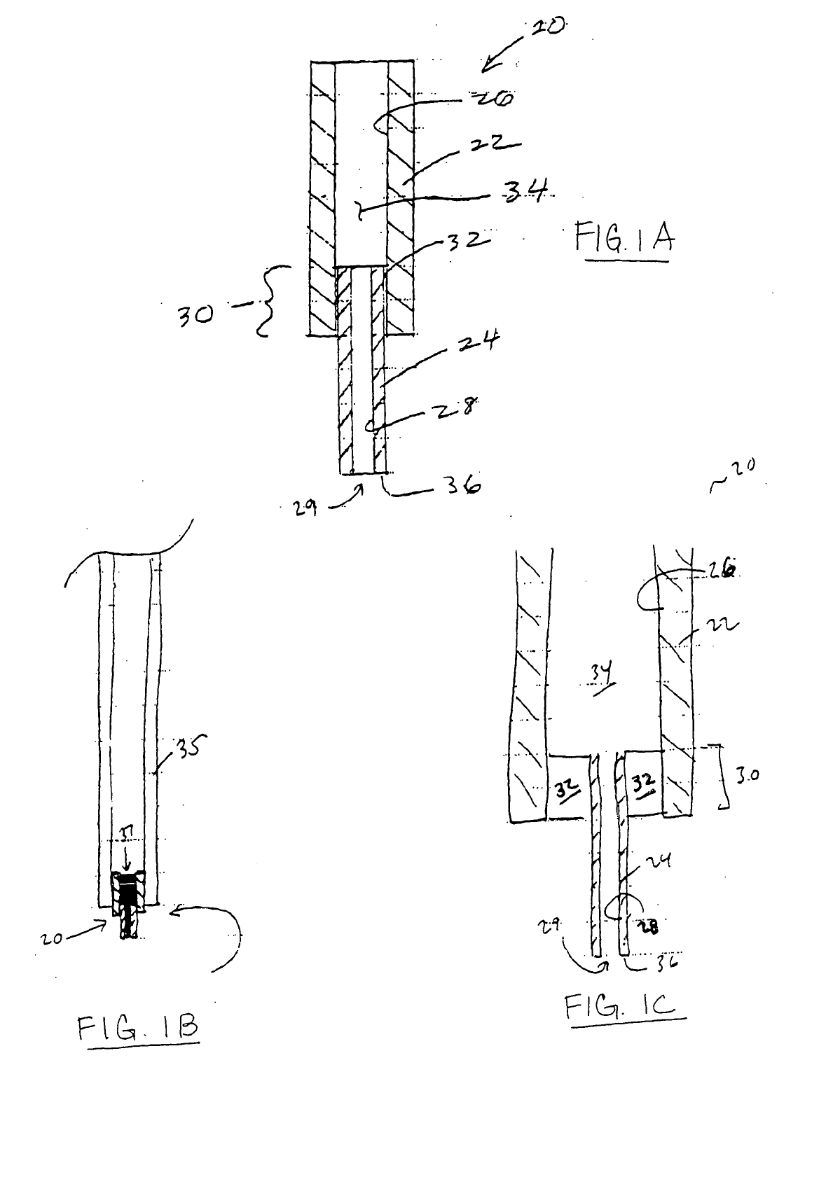

FIG. 1(a) is a schematic cross-sectional elevation drawing of an embodiment of a capillary tube printing tip wherein a smaller diameter first (printing) capillary tube is partially overlapped by the distal end of a larger diameter second (reservoir) capillary tube so as to provide a larger diameter liquid material reservoir located above the smaller diameter active printing tip.

FIG. 1(b) is a schematic cross-sectional elevation drawing of the embodiment of a capillary tube printing tip of FIG. 1(a) mounted in a tip holder and further showing the level of liquid material in the tip after loading.

FIG. 1(c) is a schematic cross-sectional elevation drawing of a slight variation of the embodiment of the capillary tube printing tip of FIG. 1(a).

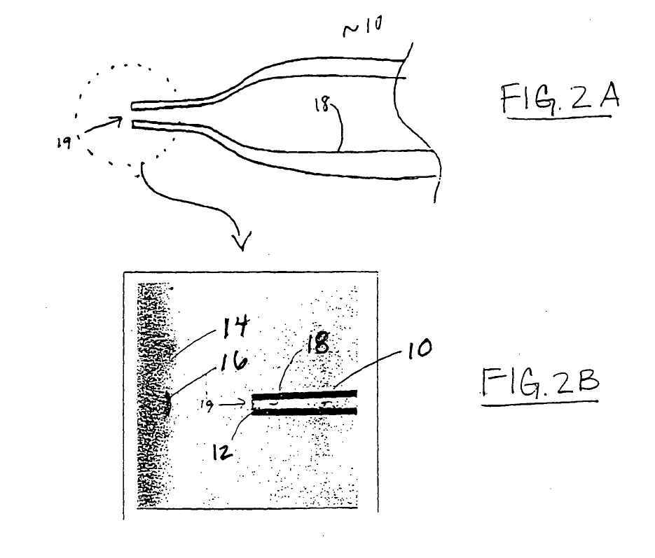

FIG. 2(a) is a side cutaway view of another embodiment of a microarray printing tip in accordance with the present invention, constructed from a glass capillary tube that tapers outward from the distal to the proximal end.

FIG. 2(b) is a photograph of the distal end of the microarray printing tip of FIG. 2(a) and further showing a deposited drop. The capillary tube shown in FIG. 2(b) is 90 microns in diameter. The drop produced by it is approximately 100 microns.

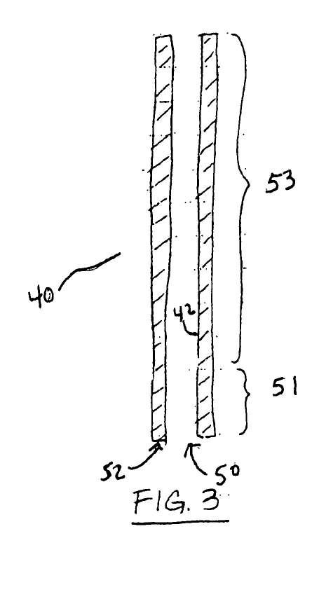

FIG. 3 is a side cutaway view of yet another embodiment of a microarray printing tip in accordance with the present invention, constructed from a glass capillary tube of uniform bore geometry but with a hydrophilic treatment applied to the inner bore surface to provide a gradient in surface forces from the distal to the proximal end.

### BEST MODE FOR CARRYING OUT THE INVENTION

In FIGS. 2(a) and 2(b), a first embodiment of a microarray printing tip in accordance with the present invention is illustrated. The tip is constructed as a capillary tube 10 having an inner bore 18. The inner bore 18 has an opening 19 at the distal (contact) end of the tube 10. An annular contact surface 12 surrounds the opening 19. The inner bore 18 has an inner diameter and an axial length that define a liquid reservoir volume which, in cooperation with capillary and surface forces applied at the interface between the liquid material and the inner surface of the inner bore, allows the tube 10 to receive and retain an appropriate amount of the liquid material.

As seen in FIG. 2(a), the diameter of the tube 10 and inner bore 18 increases from the distal (contact or printing) end (FIG. 2(b)) to the proximal (reservoir) end to provide a desired gradient in surface forces applied to the liquid material. As will be understood by those skilled in the art, the capillary forces holding the liquid material within the tube 10 increase as the inner diameter of the tube decreases. The variation in inner bore diameter therefore functions as a means for providing a desired surface force gradient, where surface forces are a function of both the liquid/solid surface tension and capillary radius. When the contact surface 14 is moved proximate the surface of a microarray printing substrate, the tube 10 draws and deposits a drop 16 of the liquid material from the inner bore 18. The tube 10 shown in FIG. 2 is a glass capillary tube having an outside diameter of 90 microns. However, other materials, such as stainless steel, can be used to form the tube.

Also, depending on the characteristics of the liquid to be deposited, on the desired geometry of the spot to be printed on the substrate, on the ambient printing conditions including humidity, and on the nature of the substrate surface, the dimensions of the inner bore and contact surface can be varied. For example, for DNA microarray printing, the inner diameter of the inner bore 18 can range from 10 to 2000 microns, with an axial length of 100 microns to 10 cm. The diameter of the contact surface (outer diameter of the tube at the distal end) can range from 10 to 2000 microns.

FIG. 1(a) shows a second embodiment of a microarray printing tip 20 constructed from concentric first and second capillary tubes 24 and 22. The second capillary tube 22 (reservoir tube) has an inner bore 26 defining a liquid reservoir 34. The inner diameter of the inner bore 26 is larger than the outer diameter of the first capillary tube 24 so that the second capillary tube 22 partially overlaps (at region 30) the proximal end of the first capillary tube 24.

The first capillary tube 24 (printing tube) has an inner bore 28 in fluid communication with the inner bore 26 of the second capillary tube 22. The inner bore 28 has a bore opening 29 at the distal end of first tube 24. An annular contact surface 36, preferably flat, is formed at the distal end of the first capillary tube 24. The contact surface 36 surrounds the opening 29 from the inner bore 28 of the first capillary tube 24.

The axial length and inner diameter of the inner bore 26 of the second capillary tube 22, in cooperation with capillary and surface forces, are adapted to receive and retain an amount of the liquid material within the reservoir 34. Similarly, the axial length, inner diameter, and inner bore surface of the first capillary tube 24 are adapted for drawing the liquid material retained in the reservoir 34 by capillary action and depositing a drop of the liquid material on the printing substrate when the contact surface 36 is moved proximate the substrate. The larger inner bore diameter of the second capillary tube 22 as compared to the inner bore diameter of the first capillary tube 24 functions to provide a surface force gradient that increases from the proximal to the distal end of the pin 20.

The first and second capillary tubes 26 and 24 can be made from glass or, in a preferred embodiment, from stainless steel. In the embodiment of FIG. 1(a), the second tube 22 has an outside diameter of 800 microns and an inside diameter of 180 microns. The first capillary tube 24 has an outside diameter of 170 microns so that it closely fits within the inner bore 26 of second capillary tube 22. The inner bore 28 of the first capillary tube has an inside diameter of approximately 100 μm. Again depending on the characteristics of the liquid to be deposited, on the desired geometry of the spot to be printed on the substrate, on the ambient printing conditions including humidity, and on the nature of the substrate surface, the dimensions of the inner bores and contact surface can be varied. For example, for DNA microarray printing, the inner diameter of the inner bore 26 can range from 25 to 4000 microns, with an axial length of 500 to 4000 microns. The inner diameter of the inner bore 28 can range from 5 to 250 microns, with an axial length of 500 to 1500 microns. The diameter of the contact surface 36 (outer diameter of the tube) can range from 15 to 500 microns.

To assemble the tip 20, the first (printing) tube 24 is inserted a distance 30 into the second (reservoir) tube 22, and is held in place therein by adhesive or the like as indicated at 32.

FIG. 1(b) shows the tip 20 fixed in a tip holder 35 after an effective volume of liquid material 37 has been loaded into the reservoir 34 and first inner bore 28 of the tip 20.

FIG. 1(c) illustrates a slightly different version of the embodiment of the microarray printing tip of FIG. 1(a) in which the outer diameter of the first capillary tube 24 is smaller than the inner diameter of the second capillary tube 22.

FIG. 3 shows a third embodiment of a capillary tube printing tip in accordance with the present invention, constructed from a single glass capillary tube 40 having an inner bore 42 of uniform geometry. The distal (contact) end of tube 40 has a contact surface 52 surrounding the bore opening 50. The inner bore 42 is sized and shaped to receive and retain by capillary force an effective deposition volume of the liquid material. Similarly, the contact surface 52 and bore opening 50 are adapted for depositing a drop of the liquid material when the contact surface 52 is moved proximate the printing substrate. A key design feature of using two capillary tubes as shown in the embodiment of FIGS. 1(a)-1(c) is the ability to modulate the relative strength of surface forces between the printing and reservoir capillary tubes. This functionality can also be attained by using a hydrophilic surface treatment to provide a gradient in surface forces along regions of a single capillary tube. Thus, applying a surface treatment to the surface of the inner bore 42 at region 51 near the distal end of the tube 40 would preferentially draw fluid from the less hydrophilic region 53 of the capillary tube 40, which would function as a reservoir. Modulating the relative strength of the surface forces along the axial length of the capillary tube 40 can then be used to control deposition characteristics. A number of commonly available silane compounds with a range of functional groups could be used to derivatize the interior of the capillary for this application. One example is N-octadecyl triethoxy silane.

With regard to each of the embodiments shown, it is important that the contact surface be made as flat as possible. More specifically, any variation in flatness of the contact surface which would cause a separation of the contact surface from the microarray substrate surface which is being printed should be substantially less than the inside diameter of inner bore. Also, it is important that the contact surface have an appropriate surface finish so as to aid in wetting of the contact surface. If the capillary tube is made from glass or stainless steel, a satisfactory contact surface can be provided through the use of a high precision disc polisher of the type utilized to polish optical fibers, using a 12 microgrit abrasive sheet.

In some applications, the concentric tube embodiment of FIG. 1 has been found to be preferable to the straight capillary tube of FIG. 3, due to the interaction of the capillary forces in the smaller diameter inner bore 28 as compared to the larger diameter reservoir 34. As will be understood by those skilled in the art, the capillary forces holding liquid within a tube increase as the inner diameter of the tube decreases. In the embodiment of FIG. 1, a smaller stainless steel capillary tube acts as the printing tip, drawing liquid from the larger capillary tube which acts as a reservoir. The smaller diameter of the printing capillary tube exerts a greater surface force and automatically draws liquid solution from the reservoir capillary tube. Pin deposition can be controlled by the diameter of the printing capillary tube (to control spot diameter), and by the ratio of the printing and reservoir capillary tube radii (to control volume dispensed by pin). The reservoir volume can be adjusted by changing the axial length of the reservoir capillary tube.

Thus, if a long, single diameter capillary tube is used, as liquid feeds out the contact (distal) end of the tube, the liquid remaining high in the capillary tube will find it difficult to flow toward the contact end. On the other hand, when the majority of the volume of the liquid to be transferred is placed in a larger diameter reservoir 34, then the smaller diameter tube 24 can more easily draw fluid from the larger diameter reservoir 34 due to the higher capillary forces acting on the smaller diameter inner bore 26.

This simple design provides a number of manufacturing advantages. Critical geometry features of the capillary pin are automatically fixed by the constant diameters of the printing and reservoir capillary tubing. Controlling the diameter of the printing tip (to control spot size) becomes trivial because grinding the tip flat does not affect tip diameter. Manufacturing matched sets of capillary printing tips with the same diameter and spot volume is easily accomplished by using the same gauge of tubing. Axial lengths of capillary and reservoir tubing appear to be less critical to printing characteristics. The technology for manufacturing capillary tubing stock well developed—high precision capillary tubing tolerances of plus or minus 5-6 um can be purchases in a range of suitable sizes. Diameters <150 um can be custom ordered.

Because critical dimensions of the capillary printing pins are fixed, the manufacturing precision required to produce the pins is greatly reduced. One method of assembling capillary tube printing tips pins in accordance with the present invention is using an adjustable alignment jig. The jig is adjusted to hold the printing and reservoir capillary tubes in concentric alignment. The tubes are bonded together by wicking a small volume of 5-minute epoxy between the tubing overlap. After the adhesive cures, the assembly is removed from the jig and the printing capillary tube is cut and ground to the desired length. A capillary printing tip can be assembled in approximately 20 minutes by this method, including 15 minutes for the adhesive to cure sufficiently.

Other methods can be used to improve the speed and precision of manufacturing. One approach is using an array of high precision jigs. This would allow many pins to be assembled simultaneously. Assembly speed could be increased by using photo-curing or heat curing adhesives. A variety of suitable adhesives are available which can be cured to a working strength in a matter of seconds or minutes, including epoxy adhesives.

Custom manufactured reservoir tubing can be used with an inner diameter that would fit the outer diameter of the printing capillary tube, and an outer diameter which would facilitate mounting to a printing head. Capillary tubing can be custom manufactured with extremely high precision. The desired printing characteristics can be achieved and automatically assembly facilitated if the concentric capillary tubes have a concentric dimensional precision of less than 25 microns. This would simplify manufacturing because achieving the required level of axial precision for the tubing assembly would become almost trivial.

The relatively simple manufacturing demands associated with capillary tube design improves commercial production. Critical dimensions of the design are fixed by the high precision of the capillary tubes. Achieving suitable levels of precision for less critical elements of the design is within the capabilities of conventional manufacturing techniques.

Capillary tube printing tip design significantly improves spot morphology and reproducibility. Printing characteristics of capillary pin printing 6×SSC printing solution were tested using a robot to deposit a CY3 analog to glass over 450 consecutive spots. During course of a 450 spot deposition pattern, spot fluorescence remains constant. The biggest improvements in using 6×SSC comes in improvements to intra-spot variation. Intra-spot CV improved from approximately 0.75 to about 0.4. Maintaining consistent concentration and fluid properties leads to consistent deposition characteristics. All spots had a coefficient of variations of 5% and 8% for size and deposition volume respectively.

Inconsistencies in the deposition volume and spot morphology of probe spots create variations in probe attachment density. These variations affect hybridization parameters which ultimately affect the accuracy of microarray analysis. Capillary tube printing tips were used to print 144 spot patterns from a single aliquot of printing solution that contained a unique 465 bp probe DNA. Spots were printed at a relative humidity of 70%. After printing, the slides were processed according to recommended protocols to prepare for hybridization. All spots were hybridized with a single aliquot of solution containing two target DNA segments. The first segment, complementary to the attached probe, was labeled with Cy-3 fluorescent markers. The second segment was not complementary to the attached probe and was labeled with Cy-5 fluorescent markers. Following hybridization and processing according to recommended protocols, the slides were scanned in a confocal scanner and assessed for levels of complementary and non-complementary hybridization. Although all spots were printed using the same probe solution and simultaneously hybridized under identical conditions, considerable variation in hybridization levels and hybridization specificity existed across different spots. Variations in probe attachment density are known to affect levels of probe hybridization capacity and specificity. Presumably, variation in probe deposition resulted in variation in levels of complementary and non-complementary hybridization. If this is indeed the case, variations in printing could account for variations of over 45% in microarray analysis.

To assist in the development of a capillary tube printing tip of known characteristics, the printing characteristics of a 265 micron (o.d.) glass capillary tube constructed in accordance with the embodiment of FIGS. 1(a)-1(c) were tested. A robot deposited a CY3 analog to glass over 225 consecutive spots. In this experiment, a borosilicate glass capillary tube with an inner dimension of 150 um and an outer dimension of 268 um was cut to a length of approximately 15 mm. The printing capillary (first tube 24) was fixed with adhesive to the reservoir capillary (second tube 22) with an inner radius of 500 microns. The contact surface was polished with 12 microgrit calcite alumina abrasive to provide a surface that was both flat and hydrophyllic. The pin was loaded with a 3× solution of SSC buffer that contained dilute Cy-3 analog dye (tetramethylrhodamine labeled dextran). The pin was used to print a 15 by 15 array of spots onto an untreated microscope slide. The printed slide was scanned for Cy-3 fluorescence to assess spot morphology and deposition quantity. The resulting spots printed with very consistent size and deposition volume. All spots had a coefficient of variations of 5% and 8% for size and deposition volume respectively.

Reproducible design and development techniques can be used to adapt the geometry of a capillary tube printing tip to a particular microarray printing application. Capillary tube tips can be evaluated over different ranges of ambient humidity and duration of pin contact with the substrate. Variations of spot deposition volume and morphology can be assessed across consecutive spots printed by a single tip, and across spots printed by different tips the same type. Performance of each tip geometry can be evaluated based on the number of spots that can be printed from a single loading of printing solution, volume of deposition, spot morphology, and consistency of spot deposition and morphology.

Using video microscopy, deposition volume can be obtained from a shadow profile of the drop deposited on the slide. Drop volume can be calculated by subtracting the volume of the right cone contained within the spherical section outlined by the drop contained on the slide surface. The images can also be used to compute the contact angle formed by the drop on the slide surface. Preliminary data suggest that this spherical approximation is quite accurate in describing the shape of the drop deposited on the slide surface.

In scanner experiments, deposition volumes can be assessed by robot printing of fluorescently labeled DNA solutions and comparing fluorescence against reference volumes and concentrations. Fluorescence of printed spots can be assessed by a confocal fluorescence slide scanner. Statistical measurements are performed by automated microarray analysis software and include measurements of deposition volume and consistency of consecutive spots, and uniformity within each spot. The deposition volume and morphology of each spot can be assessed for each pin by printing a 400 spot pattern of solution containing fluorescent labeled DNA onto glass slides. To facilitate comparison of absolute fluorescence between slides scanned at different sensitivity settings, a calibration curve can be constructed by measuring fluorescence of an array of Cy-3 concentrations at different scanner settings. All slides can then be scanned after processing at a laser power of 95% and a photomultiplier setting of 95% to confirm that the processing protocols did not introduce fluorescence to the slides. The total deposition volume of each spot is then assessed by computing the total fluorescence as estimated by multiplying the average spot fluorescence times the spot area and comparing it to total fluorescence of known deposition volumes of reference dye solutions of the same concentration. Measured parameters include intra-spot fluorescence intensity average and standard deviation, spot area, inter-spot fluorescence intensity average and standard deviation for each tip and across multiple tips of the same design. The graph below shows the fluorescence of spots deposited by a glass capillary tube printing tip (C.V.=0.08):

[image]

Printing tests can be conducted on a microarray printing robot over a range of ambient humidity conditions, using a HEPA filtered humidity controlled environment which houses the printing robot. Different contact durations of the printing tips with the microarray substrate can be achieved by adjusting the printing speed of the robot. Observed behavior is then compared to theoretical predictions to validate design models for improved printing pin designs.

Once a minimum contact duration is established for a particular application, further testing can focus on the effects of varying ambient humidity conditions. Reducing the order of experimental variables will simplify analysis and focus testing on the most significant factors influencing printing behavior.

Transfer of fluid from pins to microarray substrate is controlled by the interplay of surface tension forces between the pins, substrate, and printing solution. Surface tension forces within the pin may be estimated by the capillary height equation originally derived by Young and Laplace.

$${P}_{ambient} - {P}_{capillary} = \frac{2 γ}{{r}_{capillary}}$$

Liquid is drawn and maintained inside the capillary lumen by low pressure achieved by interaction of the fluid with the capillary walls.

Surface tension forces on both the microarray substrate and outer surface of the printing pin may be estimated by analysis of surface free energy which gives rise to Young's equation.
ΔG=ΔA(γ_{solid-liquid}−γ_{olid=air})+ΔA(γ_{liquid-air} cos(Θ−ΔΘ))
A volume of liquid will spread across a surface displacing the surface free energy of the substrate with that of the free energy of the liquid-substrate interface until it achieves a state of minimum free energy.

The size and volume of a printed spot are the product of the geometry, surface free energy, and liquid surface tension forces which combine to achieve the minimum total free energy of forces between the pin, substrate, and liquid. Detailed analysis of the forces arising from these interactions should suggest approaches by which the free energy and geometry of the pin and substrate interface, and the surface tension characteristics of the liquid can be manipulated to achieve the desired spot characteristics.

Loading pins with printing solution and the solution's subsequent adhesion and spreading on the outer and inner (lumen) pin surface is controlled by the surface forces between the pin and liquid, and may be estimated by Young's equation shown above. Pin surfaces with a high surface free energy promote spreading and adhesion of liquid. By altering the pin surface it is possible to change the surface free energy and in so doing, change the spreading and adhesion behavior of liquid in contact with the pin. Several hydrophobic and hydrophilic treatments may be applied to metal and glass pin surfaces to alter surface free energy. The treatments may be used to modulate the bore surface energy from the distal to the proximal ends of the bore. Non-covalent, solvent based treatments include several hand held hydrophobic markers designed to apply a thin hydrophobic coating. Covalent treatments include silane chemistry in combination with long hydrophobic alkane chains or hydrophilic amine or similarly charged groups. Such coatings may even be applied to specific parts of pins to promote specific geometries of spot formation and printing. By strategic placement of hydrophobic and hydrophilic surface treatments, it should be possible to alter the equilibrium geometry of the pin-substrate-liquid interface, to achieve desired spot characteristics.

As further considerations in the design of a specific capillary tube printing tip adapted for a specific microarray printing application, the viscosity of the printing solution and duration of pin contact with the substrate will likely affect the time required to establish equilibrium of the printing solution distribution at the pin-substrate contact point. It is expected that some minimum time will be required to achieve equilibrium. It expected that printing characteristics will vary considerably with combinations of contact duration and viscosity that do not establish equilibrium. Deposition should become more consistent for combinations of viscosity and contact duration which match or exceed the minimum time to establish equilibrium conditions.

Changing the surface tension of the printing solution is expected to affect both the volume of deposition and spot morphology. Deposition volume is likely to be influenced by the equilibrium conditions at the pin-substrate point of contact and liquid surface tension is likely to play an important role. Spot size is likely to be influenced by the surface tension of the printing solution on the substrate.

Thus, although there have been described particular embodiments of the present invention of a new and useful Capillary Tube Printing Tips for Microarray Printing, it is not intended that such references be construed as limitations upon the scope of this invention except as set forth in the following claims.

What is claimed is:

1. A printing tip for depositing spots of a liquid material on a microarray printing substrate comprising:
a. a first capillary tube having a distal end, a proximal end, and an inner bore, the inner bore having a distal bore opening at the distal end of the first capillary tube, the inner bore having an axial length and inner diameter adapted to receive and retain by capillary force an effective deposition volume of the liquid material;
b. the distal end of the first capillary tube defining an annular contact surface around the distal bore opening, the contact surface and distal bore opening adapted for drawing the liquid material from the inner bore and depositing a drop of the liquid material on the printing substrate when the contact surface is moved proximate the substrate; and
c. gradient means to apply increased surface forces to the liquid material within the tip at a distal end of the tip compared to a proximal end of the tip.

2. The printing tip of claim 1 wherein the gradient means comprises a first capillary tube having an inner bore diameter at the distal end of the tube that is smaller than the inner bore diameter at the proximal end of the tube.

3. The printing tip of claim 1 wherein the gradient means comprises a hydrophilic coating applied to a region of the inner bore proximate the distal end of the tube.

4. The printing tip of claim 1 wherein the contact surface is polished to enhance active wetting of the contact surface by the liquid material.

5. The printing tip of claim 1 wherein the annular contact surface is flat.

6. The printing tip of claim 1 wherein the gradient means comprises a second capillary tube joined to and partially overlapping the distal end of the first capillary tube, the second capillary tube having an inner bore in fluid communication with the inner bore of the first capillary tube, and wherein the inner bore of the second capillary tube is functional to act as a reservoir for the liquid material.

7. The printing tip of claim 6 wherein the second capillary tube is joined to the first capillary tube by an adhesive.

8. The printing tip of claim 7 wherein the adhesive is heat cured.

9. The printing tip of claim 7 wherein the adhesive is photo-cured.

10. The printing tip of claim 1 wherein the first capillary tube has an outer diameter in the range of 15 to 500 microns.

11. The printing tip of claim 10 wherein the inner bore of the first capillary tube has an inner diameter in the range of 5 to 250 microns.

12. The printing tip of claim 10 wherein the inner bore of the first capillary tube has an axial length in the range of 500 to 1500 microns.

13. A tip for depositing a liquid material on a microarray printing substrate comprising:
a. a reservoir section;
b. a contact section having a proximal end and a distal end, the proximal end of the contact section joined to the reservoir section, the contact section further comprising an inner bore extending upward from a bore opening at the distal and of the contact section, the bore in fluid communication with the reservoir section, the distal end of the contact section further defining a contact surface adjacent the bore opening;
c. the reservoir section is adapted to receive and retain by capillary force an effective deposition volume of the liquid material; and
d. the contact surface and bore opening are adapted for depositing a drop of the liquid material when the contact surface is moved proximate the printing substrate.

14. The printing tip of claim 13 wherein the reservoir section comprises a proximal region of the inner bore having an inner diameter the is larger than the inner diameter of the inner bore proximate the contact surface.

15. The printing tip of claim 13 wherein the contact surface is flat.

16. A contact printing tip for printing a spot of a liquid material on a microarray printing substrate comprising:
a. first and second concentric capillary tubes, the second capillary tube having an inner bore with an axial length, and an inner diameter that is larger than an outer diameter of the first capillary tube so that the second capillary tube partially overlaps a proximal end of the first capillary tube;
b. the first capillary tube having an inner bore in fluid communication with the inner bore of the second capillary tube;
c. the first capillary tube further comprising a contact surface at a distal end of the first capillary tube, the contact surface surrounding an opening from the inner bore of the first capillary tube;
d. the inner bore of the second capillary tube having an axial length, an inner diameter, and inner bore surface adapted to receive and retain an amount of the liquid material; and
e. the inner bore of the first capillary tube having an axial length, an inner diameter, and an inner bore surface adapted for drawing the liquid material retained in inner bore of the second capillary tube by capillary action and depositing a drop of the liquid material on the printing substrate when the contact surface is moved proximate the substrate.

17. The printing tip of claim 16 wherein the inner bore of the first capillary tube has an inner diameter in the range of 5 to 250 microns.

18. The printing tip of claim 17 wherein the inner bore of the second capillary tube has an inner diameter in the range of 25 to 4000 microns.

19. The printing tip of claim 18 wherein the inner bore of the first capillary tube has an axial length in the range of 500 to 1500 microns.

20. The printing tip of claim 19 wherein the inner bore of the second capillary tube has an axial length in the range of 500 to 4000 microns.

21. The printing tip of claim 16 wherein the first capillary tube comprises stainless steel.
